(19) United States
(12) Patent Application Publication
(10) Pub. No.: US 2007/0079921 A1
(43) Pub. Date: Apr. 12, 2007

(54) Pivoting splice stitcher and method of stitching an angled splice

(76) Inventors: Steven John Phippen, Napanee (CA); David Michael Dejacimo, Louisville, OH (US); Paul Edward Rust, Lawton, OK (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/248,670

(22) Filed: Oct. 12, 2005

(51) Int. Cl. B29D 30/08

(52) U.S. Cl. 156/130.3; 156/421

(57) ABSTRACT

The invention provides a stitcher and a method of stitching a helical splice having an angle φ on material mounted on a drum, the method comprising the steps of: rotating the drum at a constant speed U, traversing a stitcher assembly at a constant velocity V, wherein the stitcher assembly velocity is coordinated with the drum speed so that the stitcher engages the ply along the helical splice. The invention further provides a stitcher having a roller rotatably mounted to a support frame having a longitudinal axis, wherein the roller is pivotally mounted to the support frame so that the roller can pivot about the longitudinal axis of the handle.

### FIELD OF THE INVENTION

The invention relates to a stitcher for tire manufacturing, and more particularly to a stitcher for stitching in an axial direction or in a helical path.

### BACKGROUND OF THE INVENTION

In the art of tire building, stitching is an essential operation directed to the purpose of eliminating air and other gasses trapped between the tire components on a green carcass. Stitchers typically comprise a wheel or roller rotatably mounted on an axle that applies pressure to the tire components mounted on a tire building drum. The stitcher typically rolls against the component in a direction approximately perpendicular to the longitudinal axis of the tire building drum. As the stitcher rolls against the component, the pressure forces the trapped air out from between the tire components as well as to increase the adherence of the components.

One disadvantage to prior art stitchers is that they are generally not capable of stitching along an angled splice. Typically angled splices are stitched manually.

### SUMMARY OF THE INVENTION

The invention provides in a first aspect a method of stitching a helical splice having an angle φ on material mounted on a drum, the method comprising the steps of: rotating the drum at a constant speed U, traversing a stitcher assembly at a constant velocity V, wherein the stitcher assembly velocity is coordinated with the drum speed so that the stitcher engages the ply along the helical splice.

The invention further provides a stitcher having a roller rotatably mounted to a support frame having a longitudinal axis, wherein the roller is pivotally mounted to the support frame so that the roller can pivot about the longitudinal axis.

Definitions

For ease of understanding this disclosure, the following items are disclosed:

“Apex” means an elastomeric filler located radially above the bead and interposed between the plies and the ply turn-up.

“Axial” and “axially” means the lines or directions that are parallel to the axis of rotation of the tire.

“Bead” means that part of the tire comprising an annular tensile member commonly referred to as a “bead core” wrapped by ply cords and shaped, with or without other reinforcement elements such as flippers, chippers, apexes, toe guards and chafers, to fit the design rim.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Carcass” means an unvulcanized laminate of tire ply material and other tire components cut to length suitable for splicing, or already spliced, into a cylindrical or toroidal shape. Additional components may be added to the carcass prior to its being vulcanized to create the molded tire.

“Casing means the tire carcass and associated tire components excluding the tread.

“Chafers” refers to narrow strips of material placed around the outside of the bead to protect cord plies from the rim, distribute flexing above the rim, and to seal the tire.

“Circumferential” means lines or directions extending along the perimeter of the surface of the annular tread perpendicular to the axial direction.

“Cord” means one of the reinforcement strands of which the plies in the tire are comprised.

“Equatorial Plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Insert” means an elastomeric member used as a stiffening member usually located in the sidewall region of the tire.

“Ply” means a continuous layer of rubber-coated parallel cords.

“Radial” and “radially” mean directions radially toward or away from the axis of rotation of the tire.

“Radial Ply Tire” means a belted or circumferentially restricted pneumatic tire in which at least one layer of ply has the ply cords extend from bead to bead at cord angles between 65° and 90° with respect to the equatorial plane of the tire.

“Shoulder” means the upper portion of sidewall just below the tread edge.

“Sidewall” means that portion of a tire between the tread and the bead.

“Tread” means a rubber component which when bonded to a tire carcass includes that portion of the tire that come into contact with the road when the tire is normally inflated and under normal load.

“Tread Width” means the arc length of the tread surface in the axial direction, that is, in a plane parallel to the axis of rotation of the tire.

### BRIEF DESCRIPTION OF THE DRAWINGS

The invention will be described by way of example and with reference to the accompanying drawings in which:

FIG. 1 is a perspective view of a stitcher of the present invention;

FIG. 2 is a side view of the stitcher of FIG. 1;

FIG. 3 is a front perspective view of the stitcher shown in use on a tire building drum;

FIG. 4 is a view of the stitcher control system.

### DETAILED DESCRIPTION OF THE INVENTION

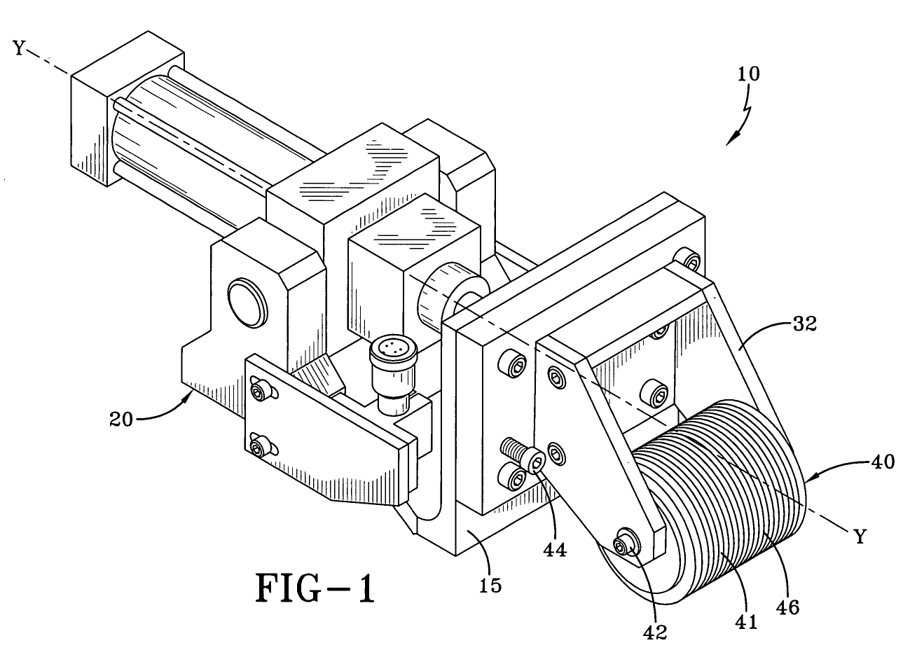

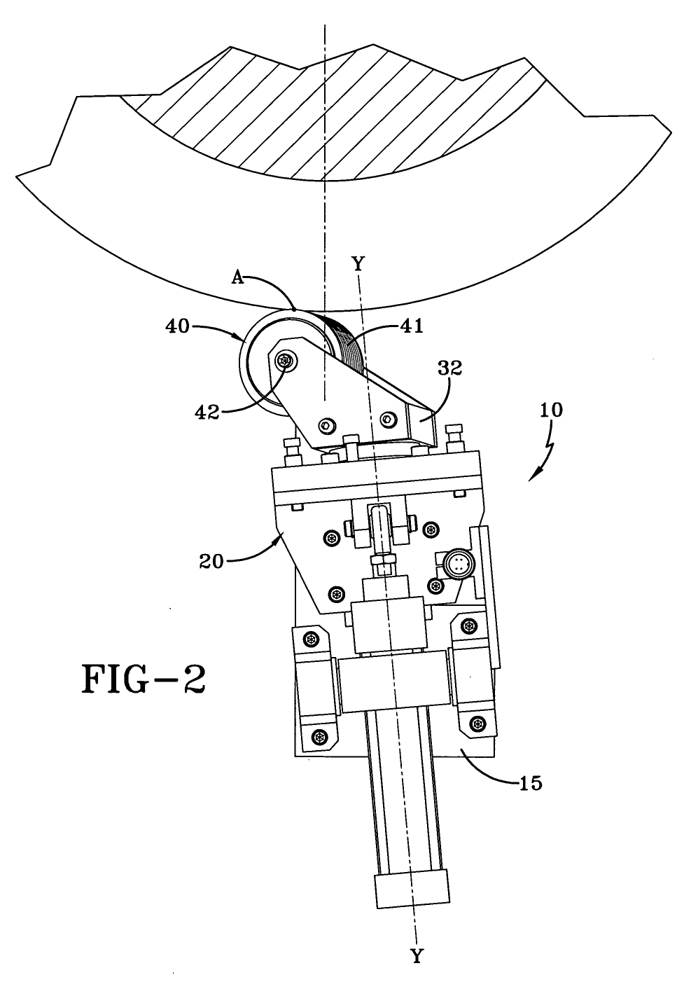

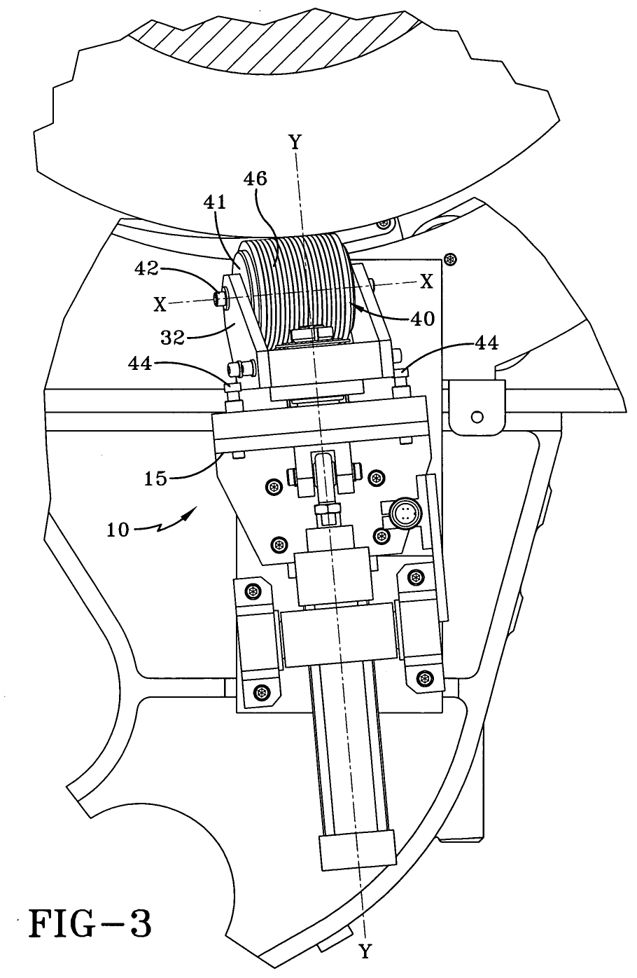

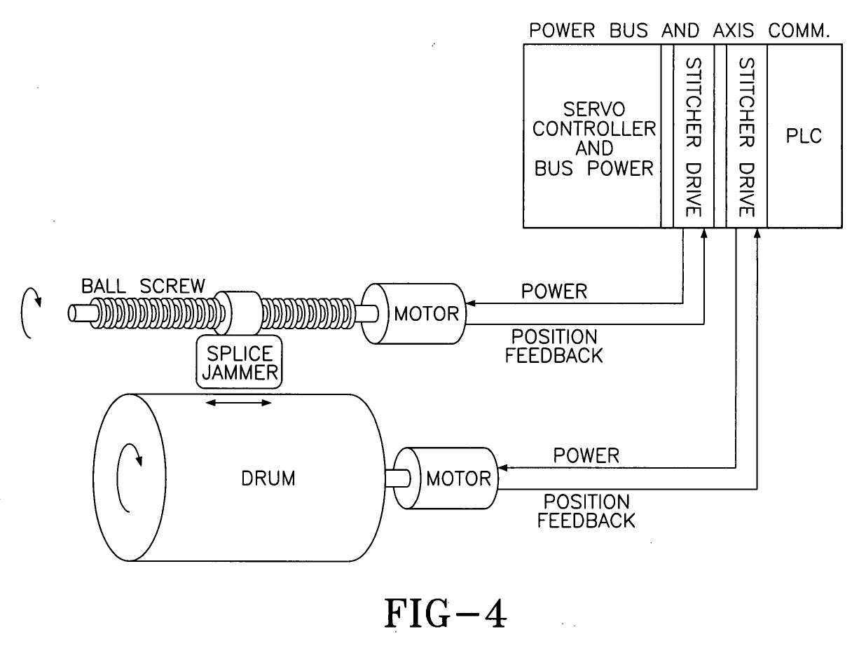

With reference to FIGS. 1 through 4, a cross-sectional view of the stitcher of the present invention is illustrated. As shown in FIG. 1, a pivotable stitcher mechanism 10 is provided. The stitcher mechanism 10 includes a mounting bracket 15 connected to a support frame 20. The stitcher mechanism includes a support rail 30 which is slidably mounted within the support frame 20 to allow translation of the stitcher mechanism along the support rail's longitudinal axis Y-Y. The mounting bracket 15 of the stitcher mechanism may be mounted upon a carriage mechanism or to an axis of a linear servo mechanism such as a ball screw as shown in FIG. 4 for translating along the outer circumference of a tire building drum, parallel to the drum's longitudinal axis.

The stitcher mechanism 10 is further provided with a pivotable head 32 having a roller assembly 40 mounted thereto. The head 32 is rotatably mounted to the support frame 20 so that the head and roller assembly 40 can rotate or swivel about the Y axis of the stitcher mechanism. One or more pivot limiters 44 may be provided on the support frame 20 to limit the rotational movement of the pivotable head 32. It is preferred that the pivotable head be capable of pivoting +/−90 degrees, more typically in the range of +/−12 degrees for stitching ply. Allowing the pivot angle to vary results in the roller following the desired helical angle of the ply. This is due to the way the roller assembly is designed. As shown in FIG. 5, the force point of contact A with the ply is offset from the longitudinal axis Y-Y of the stitcher assembly. Because the point of force contact with contact surface of the ply is offset from the pivot axis of the stitcher assembly, the stitcher roller cannot scuff the area of the splice. This is because the torque force generated by the tire building drum causes the stitcher assembly to pivot away from the drum assembly.

The roller assembly 40 is further comprised of a roller 41 rotatably mounted upon a first end of the mechanism via an axle 42. The roller 41 rotates about its longitudinal axis X-X. The outer surface of the roller 46 may comprise a rubber or elastomeric material.

The stitcher assembly is extended to the tire building drum surface once it is in position over the tire building section of the drum. In the initial start up position, the stitcher roller axis XX is about perpendicular to the longitudinal axis of the tire building drum. In order for the stitcher mechanism to stitch a helical path following the splice, the speed of the drum must be coordinated with the speed of the stitcher. First the stitcher speed V is set to a desired speed. Next, the tire building drum speed U (radians/s) is determined from the following equation:
U=[V Tan(90−φ)]/{Dπ}
where:

U is the drum speed in radians/second

V is the stitcher speed, in inches/second

φ is the ply angle

D is the diameter of the drum

The drum speed and the carriage speed of the stitcher may be geared together mechanically or be electrically controlled via a servo controller to maintain the velocity ratio defined by equation 1. The drum is rotated at the drum speed U starting from a specific location. The stitcher is also started from an initial location at the end of the drum, where the roller axis XX is perpendicular to the drum longitudinal axis YY. The stitcher is traversed across the drum at a velocity V while the drum rotates at speed U. Because of the coordination of the drum and stitcher speeds, the stitcher roller traverses the helix of the splice at the ply angle φ.

One of the unique advantages of the stitcher of the present invention is that the stitcher has a pivot between the roller and the traversing section, with the force area between the roller and the material trailing the pivot point of the assembly, allowing the stitcher to follow the helical path without any lateral force on the material to be stitched.

While certain representative embodiments and details have been shown for the purpose of illustrating the invention, it will be apparent to those skilled in this art that various changes and modifications may be made therein without departing from the spirit or scope of the invention.

What is claimed is:

1. A method of stitching a helical splice having an angle φ on material mounted on a drum, the method comprising the steps of:
rotating the drum at a constant speed U,
traversing a stitcher assembly at a constant velocity V, wherein the stitcher assembly velocity is coordinated with the drum speed so that the stitcher engages the ply along the helical splice.

2. The method of claim 1 wherein the drum speed U=[V Tan(90−φ)]/Dπ, where: V is the stitcher speed, φ is the ply angle and D is the diameter of the drum.

3. A stitcher having roller rotatably mounted to a support frame having a longitudinal axis, wherein the roller is pivotally mounted to the support frame so that the roller can pivot about the longitudinal axis.

4. The stitcher of claim 3 wherein the pivot point is not in alignment with the longitudinal axis.
